(19) United States
(12) Patent Application Publication
(10) Pub. No.: US 2006/0169155 A1
(43) Pub. Date: Aug. 3, 2006

(54) PACKING FOR A SHEET-GUIDING CYLINDER IN A PROCESSING MACHINE

(75) Inventors: Gerhard Johner, Gelnhausen-Meerholz (DE); Markus Kirst, Buttelborn (DE); Ruth Kremer, Steinbach (DE); Uwe Wilms, Schoneberg (DE); Rainer Schneider, Lorch (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignees: MAN Roland Druckmaschinen AG, Offenbach (DE); Coatec Gesellschaft fur Oberflachenveredelung GmbH & Co. KG, Schluchtem (DE)

(21) Appl. No.: 10/694,031

(22) Filed: Oct. 27, 2003

(30) Foreign Application Priority Data
Apr. 22, 2002 (WO) PCT/EP02/04387
Apr. 26, 2001 (DE) 20107183.5

(51) Int. Cl. B41F 3/54; B41F 13/00

(52) U.S. Cl. 101/174; 101/232; 428/600; 428/687

(57) ABSTRACT

A printing and/or varnishing machine having a plurality of sheet-guiding cylinders in which at least one of the cylinders has an outer detachable packing which has enhanced ink repellent characteristics and which significantly reduces wear. The packing has a layered structure which includes a flexible backing material 12, the underside of which is assigned to the base body of the sheet-guiding cylinder 3, a coating 13 of molybdenum or tungsten carbide/cobalt which is adhesively applied to the upper side of the backing material 12, and a sealing layer 14 of a material made from the group of polysiloxanes which is adhesively applied to the upper side of the coating 13. The side of the packings 5, 6 which faces the material to be printed has a surface profile consisting of cones 18 with rounded tips 16 for reduced sheet contact.

### FIELD OF THE INVENTION

The present invention relates generally to sheet-guiding cylinders for processing machines, such as printing or varnishing machines, and more particularly, to a backing or packing about the perimeter of such sheet-guiding cylinders.

### BACKGROUND OF THE INVENTION

Backings, commonly referred to as packings, are used for sheet-guiding cylinders in printing machines, particularly in first-side and second-side printing machines. In first-side and second-side printing machines, after the first side of a sheet is printed or varnished and the sheet is turned over in order to print or varnish the second side, the sheet is carried by a sheet-guiding cylinder, for example, a counter-pressure cylinder. This may cause the fresh ink or varnish from the first side of the sheet to be deposited on the cylinder jacket due to ink/varnish transfer. The jacket of the sheet-guiding cylinder must be cleaned so as to not impair the quality of the print images of the subsequent sheets.

A jacket type packing of this type is known from DE 28 20 549 A1. The packing is referred to as a sheet-guiding foil and has a two-layer structure. The first layer is a backing foil with depressions on the side that faces the material to be printed, which are produced by means of a blasting treatment. The second layer is a nickel coating layer that is deposited on the roughened surface. However, the durability of such a coating is impaired by wear on the projecting elevations of the surface, such as wear occurring from relative movement between the material to be printed and the surface of the elevations. In such event, optimal ink transfer cannot be achieved.

EP 0 017 776 A1 discloses a packing film in which the surface that comes in contact with the material to be printed is provided with structural elements in the form of spherical segments of identical height which are distributed in a statistically uniform fashion. Such a packing can be manufactured by electroforming a metallic backing foil or by pressing a plastic film with a high modulus of elasticity in order to produce the spherical segments. A cover layer of chrome is then deposited in order to compensate for the microroughness of the surfaces of the spherical segments in the backing foil. However, the thinness of the cover layer limits the service life of the packing.

Another development of a packing is known from DE 42 30 567 A1. In this case, convex structural elements have an oval shape with a radius of curvature that becomes larger from the top of an elevation to the transition into the convex structure elements.

A single-layer or multi-layer jacket for a sheet-guiding cylinder is known from EP 29 14 255 A1. The jacket has a grease-repellent, wear-resistant outer layer that contains at least 30% nickel and/or chrome. This is supplemented with additional mixtures of the elements molybdenum, tungsten, cobalt, aluminum, boron, manganese, titanium, magnesium and cerium. In one embodiment, a sealing substance, preferably Teflon or copying varnish, is introduced into the pores of this outer layer.

DE 198 50 968 A1 discloses a wear-inhibiting, ink-repellent coating—suitable for printing machine components—that consists of a material of metal oxides or hard metals that are subjected to only little wear. This coating is further treated with a sealing material from the polysiloxane group.

### OBJECTS AND SUMMARY OF THE INVENTION

It is an object of the present invention to provide a sheet guiding cylinder for printing and varnishing machines which has an outer packing or backing that permits improved ink transfer and which is substantially less susceptible to wear.

A first advantage of the packing according to the invention is that the packing has a special layered structure with an ink/varnish-repellent surface that improves the retransfer of the ink/varnish. The build-up of ink or varnish on the surface of a packing arranged on a sheet-guiding cylinder is noticeably minimized due to the enhanced retransfer characteristics.

Another advantage of the invention is that a significant reduction in ink release can be obtained when a printed or varnished side of a sheet material is carried by the outer surface of the packing. This leads to a noticeable improvement of the print quality, in particular, when operating in the first-side and second-side printing modes in multicolor printing processes.

It also is advantageous that the packing or packings with the special coating according to the invention can be quickly arranged in a detachable fashion on a single- or multi-size sheet-guiding cylinder relative to a single-size form or plate cylinder. This makes it possible to effect short set-up times when the packing or packings of a sheet-guiding cylinder must be exchanged.

Another advantage is that the surface of the packing has a reduced contact surface relative to the printed side of the sheet material. The contact surface is formed by a plurality of irregularly arranged elevations that essentially have the form of cones with rounded tips. The contact surface can be further minimized by means of a preferred structuring of the layer structure.

It also is advantageous that the packing according to the invention can be universally used on sheet-guiding cylinders in processing machines. Sheet-guiding cylinders of this type are used in printing machines (with or without varnishing mechanisms), preferably for multicolor printing processes and in the first-side printing mode and the second-side printing mode, as well as in varnishing machines, preferably multiple varnish applications and in the first-side printing mode and the second-side printing mode.

Other objects and advantages of the invention will become apparent upon reading the following detailed description and upon reference to the drawings, in which:

### BRIEF DESCRIPTION OF THE DRAWINGS

FIG. 1 is a diagrammatic depiction of a printing machine which may be operated in a first side printing mode or first side and second side printing mode, and which has a sheet guiding cylinder with a packing in accordance with the present invention;

FIG. 2 is an enlarged depiction of a packing in accordance with the invention on single-size sheet guiding cylinder of the machine shown in FIG. 1;

FIG. 3 is an enlarged fragmentary section depicting the layered structure of the packing according to the invention; and

FIG. 4 is further enlarged fragmentary section depicting the surface profile of the packing.

While the invention is susceptible of various modifications and alternative constructions, certain illustrated embodiments thereof have been shown in the drawings and will be described below in detail. It should be understood, however, that there is no intention to limit the invention to the specific forms disclosed, but on the contrary, the intention is to cover all modifications, alternative constructions and equivalents falling within the spirit and scope of the invention.

### DETAILED DESCRIPTION OF PREFERRED EMBODIMENTS

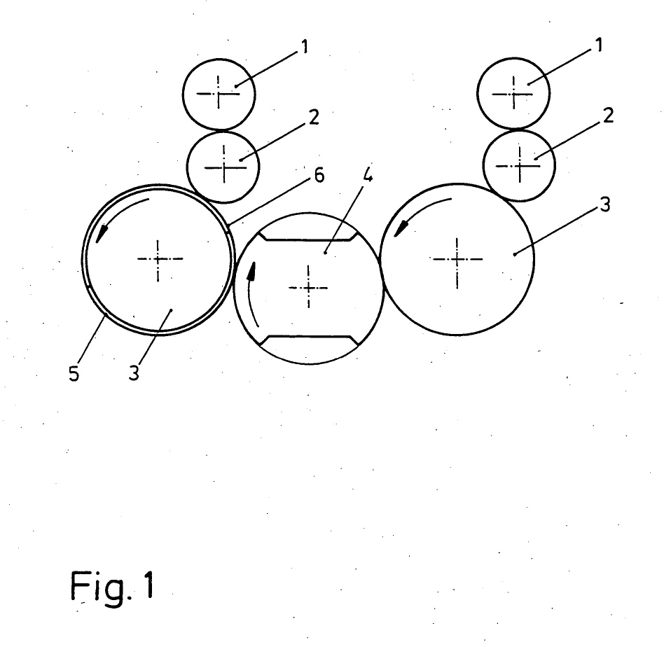

Referring now more particularly to FIG. 1 of the drawings, there is shown an illustrative sheet fed rotary printing machine which includes a plurality of printing units for multicolor printing processing. The machine also preferably is provided with conventional varnishing units. Each printing unit includes a sheet guiding cylinder 3 which in this case serves as printing cylinder, a rubber blanket cylinder 2 associated with the plate cylinder 3 and a plate cylinder 1 associated with the blanket cylinder 2. At least one turning drum 4 is located between the printing units for transporting and turning sheets following printing in the first printing unit. The turning drum 4, which may be of a conventional type, may operate on a single or multiple sheet turning principle between the sheet guiding cylinders.

The illustrated turning unit 4 is in the form of a double-size drum which may be supported on the side of the printing machine frame. The turning drum 4 is provided with two sheet retaining systems for the sheet transport in a first side printing mode or in a first side and second side printing mode, with the sheet retaining systems being located in 180° circumferential offset relation to each other.

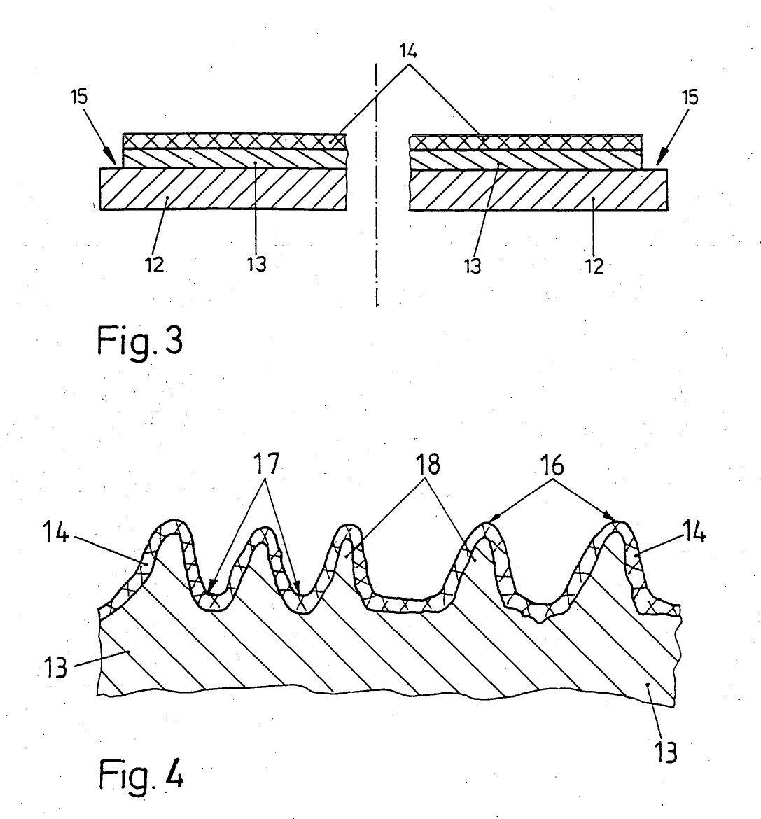

The printing cylinder 3 downstream of the turning drum 4 in this case is a double-size printing cylinder provided with first and second packings 5, 6, respectively, which are detachably arranged on diametrically opposed sides of the printing cylinder 3 and form a curved outer surface 11 for guiding and transporting the sheets. The packings 5, 6 preferably are fixed on the printing cylinder 3 by means of clamping elements 8 at a print start position and clamping elements 9 at a print end position which are arranged in at least one cylinder channel 7 of the printing cylinder as depicted in FIG. 3. It will be understood that the sheet guiding cylinder 3 downstream of the turning drum 4 as depicted in FIG. 1 may be formed with two such cylinder channels for retaining the first and second packings 5, 6, in the illustrated double-size sheet guiding cylinder. The ends of the packings 5, 6 may contain a recessed region 15 which facilitates retention of the packings 5, 6 by the clamping elements.

In accordance with the invention, the sheet guiding cylinder packings each have a multilayered structure which has improved ink repellent characteristics for multicolor printing and which resist wear. The illustrated packings 5, 6 each have a three layered structure which includes a backing material 12 (first layer) which is flexible and preferably made of metal, for example stainless steel, with an underside of the backing material 12 positioned on an outer surface 10 of the printing cylinder 3. The upper side of the backing material 12 is provided with a coating 13 (second layer) adhesively applied to the backing material 12. The coating 13 (second layer) in turn carries a sealing layer 14 (third layer) that is adhesively applied to the coating 13 and which defines an outer surface for contacting and supporting sheets during heat transfer. The coating 13 has as structured surface profile, the thickness which preferably is between 10 and 120 μm, and the roughness Rz of which preferably is between 5 and 60 μm. The coating 13 has an irregular surface profile which in this instance consists of randomly distributed elevations in the form of cones 18 with rounded tips 16 so as to define relatively small sheet contact surfaces with valleys 17 therebetween. Such a surface profile of the coating can be produced during the coating process or subsequently etched into the coating 13. As viewed in a vertical section, as depicted FIG. 4, the sealing layer 14 is adapted to the contour of the cones 18. The cones preferably are formed by individual and/or interlinked cones 18 which have the rounded tips 16. In addition, the upper side of the backing material 12 of the packings 5, 6 which faces the material to be printed can be pre-treated before the application of the coating 13, namely by means of blasting, brushing, embossing, engraving, electrical discharge machining, laser treatment or a purely chemical or electrochemical etching method.

The coating 13 consists of metals such as chromium, iron, titanium, nickel, cobalt or tungsten, their oxides such as Al₂O₃, TiO₂, Cr₂O₃, SiO₂ or ZrO₂, their carbides such as WC or Cr₃C₂ or silicides of these metals, mixtures or alloys thereof, e.g., NiCr, and variations thereof. In one preferred embodiment, the material for the coating 13 consists of pure molybdenum (Mo). Such material not only has favorable sliding properties, but is also subjected to substantial strain-hardening under mechanical stress such that an optimally hardened surface of the coating 13 is achieved after a short operating time.

The sliding properties of the coating 13 of molybdenum can be improved during the operation by forming very thin molybdenum disulfide (MoS₂) layers. These layers are formed by the interaction between the molybdenum and the sulphured components of the inks that are bound with mineral oil. In an alternative embodiment, MoS₂ is mixed with the coating powder in a quantity up to 30% by volume such that the superior sliding properties of such a molybdenum layer become effective immediately. In another embodiment, tungsten carbide/cobalt (WC/Co) is used as the preferred material for the coating 13.

The coating 13 may be directly applied to the backing material 12 or indirectly by means of a bonding agent. The coating 13 preferably is applied to the backing material 12 by means of thermal spraying. In one embodiment, the surface structure of the coating 13 subsequently can be improved by slight grinding, polishing or stripping the surface.

The ink-repellent properties of the coating 13 can be improved with the sealing layer 14. The sealing layer 14 consists of a material with a low surface energy. According to one preferred embodiment, fluorinated hydrocarbons such as acrylates, as well as fluoric polymers on the basis of PTEF and copolymers containing fluorine, may be used for this purpose. Alternatively, inorganic-organic hybrid polymers that are composed of an organic SiSi network and an inorganic Si-O network may be applied to the upper side of the coating 13. Functional groups such as alkyls, vinyls or metal oxides can be dispersed in these hybrid polymers. Alternatively, it would be possible to disperse polysiloxanes, their residual hydrocarbons, preferably methyl groups, as well as other alkyls such as phenyl groups or aryl groups. In addition, halogenated groups, in particular F and F compounds, can be incorporated into these compounds. The adhesiveness and the wear resistance of the sealing layer 14 can be improved by means of a hardening sealing layer at temperatures between 50 and 450° C.

In order to improve the wear resistance and the ink/varnish-repellent effect of the packings, the sealing layer 14, in particular the polysiloxane, may be exposed to a steam-saturated atmosphere after the manufacture of the layered packings 5, 6. A residual crosslinking of free SiH groups takes place at temperatures tₘₐₓ=120° C. over a time τ<120 min such that the sealing layer 14 is polymerized.

According to another embodiment, migration additives in the form of polydimethylsiloxanes with terminal hydrated groups can be dispersed in the sealing layer 14, particularly when using polysiloxanes. The migration additives preferably are mixed with the sealing substance during the manufacture of the sealing layer 14.

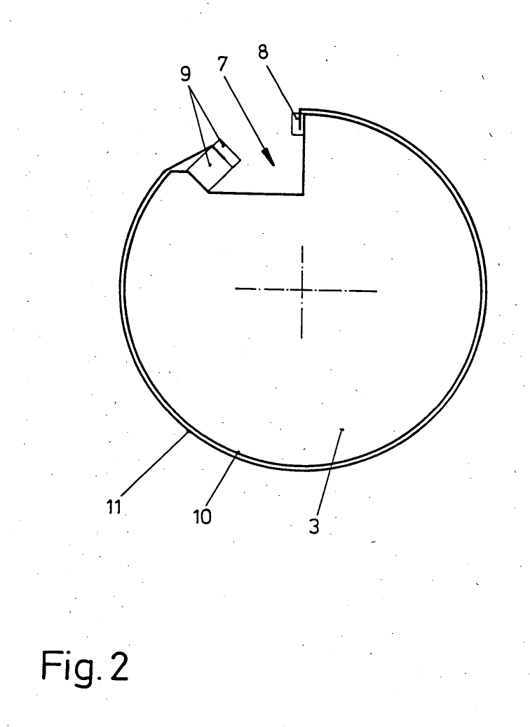

It will be understood that the design of the sheet-guiding cylinder with detachably arranged packings 5, 6 is not limited to a double-size printing cylinder 3. On the contrary, it is possible to provide single-size sheet-guiding cylinders with one base body and one packing provide 5, as depicted in FIG. 2, or triple-size to quadruple-size sheet-guiding cylinders with three or four packings 5, 6 that are symmetrically arranged on the circumference of the base body. In addition, the invention is not limited to printing cylinders 3, but can also be used for all cylinders that guide sheets, for example, feed drums, transfer drums, winding drums and impression cylinders.

1.-7. (canceled)

8. A multicolor printing machine comprising sheet guiding cylinders over which sheets are directed during a printing and/or varnishing operation, said sheet guiding cylinders each comprising a cylindrical body with at least one sheet retaining system arranged thereon, at least one of said sheet guiding cylinders having a packing (5, 6) detachably supported thereon, said packing (5, 6) having a multilayered structure including
a flexible backing material (12) supported on the body of the sheet guiding cylinder;
a coating (13) having an irregular surface profile adhesively supported on an upper surface of the backing material (12), said coating (13) being made of a hard metal that forms a surface with sliding properties; and
a sealing layer (14) adhesively secured on an upper side of the coating (13) made of a material selected from the group consisting of polysiloxane, acrylate, or fluoric polymers.

9. The printing machine of claim 8 in which said coating (13) is made of molybdenum.

10. The printing machine of claim 8 in which said coating (13) is made of a metal alloy of corrosion-proof and wear resistant metal.

11. The printing machine of claim 10 in which said coating is made of NiCr.

12. The printing machine of claim 8 in which an outer side of the packing (5, 6) which faces and supports material to be printed has a surface profile consisting of cones (18) with rounded tips (16).

13. The printing machine of claim 8 in which the sealing layer (14) is made of a polysiloxane that is polymerized in a steam-saturated atomosphere.

14. The printing machine of claim 8 in which said sealing layer (14) contains migration additives in the form of polydimethylsiloxanes.

15. The printing machine of claim 8 in which said coating (13) contains up to 30% by vol MoS₂.

16. A multicolor printing machine comprising sheet guiding cylinders over which sheets are directed during a printing and/or varnishing operation, said sheet guiding cylinders each comprising a cylindrical body with at least one sheet retaining system arranged thereon, at least one of said sheet guiding cylinders having a packing (5, 6) detachably supported thereon, said packing (5, 6) having a multilayered structure including
a flexible backing material (12), the underside of which is assigned to the body of the sheet-guiding cylinder (3),
a coating (13) of molybdenum adhesively arranged on the upper side of the backing material (12), and
a sealing layer (14) of a material of the polysiloxane group adhesively arranged on the upper side of the coating (13).

17. The printing machine of claim 16 in which an outer side of the packing (5, 6) which faces and supports material to be printed has a surface profile consisting of cones (18) with rounded tips (16).

18. A multicolor printing machine comprising sheet guiding cylinders over which sheets are directed during a printing and/or varnishing operation, said sheet guiding cylinders each comprising a cylindrical body with at least one sheet retaining system arranged thereon, at least one of said sheet guiding cylinders having a packing (5, 6) detachably supported thereon, said packing (5, 6) having a multilayered structure including
a flexible backing material (12), the underside of which is assigned to the body of the sheet-guiding cylinder (3),
a coating (13) having an irregular surface profile made of tungsten carbide/cobalt adhesively arranged on the upper side of the backing material (12), and
a sealing layer (14) of a material of the polysiloxane group adhevisely arranged on the upper side of the coating (13).

19. The printing machine of claim 18 in which an outer side of the packing (5, 6) which faces and supports material to be printed has a surface profile consisting of cones (18) with rounded tips (16).
